(19) United States
(12) Patent Application Publication
(10) Pub. No.: US 2015/0187139 A1
(43) Pub. Date: Jul. 2, 2015

(54) APPARATUS AND METHOD OF PROVIDING AUGMENTED REALITY

(71) Applicant: Electronics and Telecommunications Research Institute, Daejeon (KR)

(72) Inventor: Chung Hyun AHN, Daejeon (KR)

(73) Assignee: Electronics and Telecommunications Research Institute, Daejeon (KR)

(21) Appl. No.: 14/228,406

(22) Filed: Mar. 28, 2014

(30) Foreign Application Priority Data
Dec. 26, 2013 (KR) 10-2013-0163578

(51) Int. Cl. G06T 19/00; G06F 17/30; G06K 9/46

(52) U.S. Cl. CPC G06T 19/006; G06K 9/4604; G06F 17/30268

(57) ABSTRACT

This disclosure provides an apparatus of providing augmented reality, comprising an image obtaining unit obtaining an image including objects, a location information extracting unit obtaining location information on the image, a candidate object extracting unit extracting a target object by analyzing features of a subject in the image, defining the objects in a space as candidate objects, and extracting information on directions of the candidate objects from a center of the image, a final candidate object determining unit determining a final candidate object using the location information on the image, the directions of the candidate objects, and each relationship in phase between the objects, and an object information extracting unit searching information on the final candidate object based on the location information on the final candidate object in a space information database and displaying the information on the final candidate object on the image.

This application claims the benefit of priority of Korean Patent Application No. 10-2013-0163578 filed on Dec. 26, 2013, the entire disclosure of which is incorporated by reference herein, is claimed.

### BACKGROUND OF THE INVENTION

1. Technical Field

The present invention concerns video augmented reality utilizing location information, and more specifically, to an apparatus and method of providing augmented reality.

2. Discussion of Related Art

With the recent growth of digital image processing technology, so-called augmented reality (AR) is being commercially available.

Augmented reality is a sort of virtual reality technology in which a real-life world viewed by a user's eyes and a virtual world with additional information are mixed to provide a single image to the user. This is a hybrid VR system having a real-life environment and a virtual environment converged and has been in research and development by the U.S. and Japan since back in late 1990's.

In contrast to the existing virtual reality technology, augmented reality features capability of offering enforced additional information that is difficult to obtain from the real-life world by adding virtual objects to the real-life world. Such feature enables application to various actual environments unlike the existing virtual reality technology which has limited application such as video games and in particular draws attention as a next-generation display technology that is suitable for ubiquitous environment.

Augmented reality technology is in a trend of being applicable to various fields including recent remote medical diagnosis, broadcast, construction design, manufacturing process management, attraction guide. An example is wearable computer technology that is an outside implementation of augmented reality. A special display device that may be put on a user's head shows, in real time, computer graphic and letters overlapping the real-life world viewed by the user, enabling augmented reality. Accordingly, research for augmented reality focuses primarily on development of wearable computers, and an example is video-based or optic-based HMD (Head Mounted Display).

More demand for smart terminals led to an increase in applications related to location-based mobile AR. To properly support mobile AR, information on all the objects in an image needs to be previously stored in a database (DB) so that if a corresponding image is entered, its relevant information may be extracted from the database and may be provided to the user. To offer such service, however, a significant amount of information should be pre-treated. Further, a highly advanced technology for an object in an image is required in order to recognize the image, and this is not practical yet.

However, the conventional augmented reality methods need a terminal to be oriented towards a building from which the terminal intends to obtain information, and this restricts the type of the terminal to a mobile device that is movable. Further, since a separate database for additional information is established for each and every region, the service coverage is limited, and more time and expense are required for wide application. Further, this technology is applicable only to images that are captured in real time from a mobile terminal, but not to location-based AR for geo-tagged images already acquired.

Thus, a need exists for an apparatus and method of providing augmented reality, which may also apply to geo-tagged images that have been previously obtained from, e.g., Internet.

### SUMMARY OF THE INVENTION

An object of the present invention is to provide an apparatus and method of providing augmented reality.

Another object of the present invention is to provide an apparatus and method of providing augmented reality which may be also applicable to geo-tagged images that have been previously obtained from, e.g., Internet.

Still another object of the present invention is to provide an apparatus and method of providing augmented reality which may provide additional information using information over the Internet without the need of pre-establishing data.

According to an aspect of the present invention, there is provided an apparatus of providing augmented reality. The apparatus may comprise an image obtaining unit obtaining an image including objects, a location information extracting unit obtaining location information on the image, a candidate object extracting unit extracting a target object by analyzing features of a subject in the image, defining the objects in a space as candidate objects, and extracting information on directions of the candidate objects from a center of the image, a final candidate object determining unit determining a final candidate object using the location information on the image, the directions of the candidate objects, and each relationship in phase between the objects, and an object information extracting unit searching information on the final candidate object based on the location information on the final candidate object in a space information database and displaying the information on the final candidate object on the image.

In an aspect, the image obtaining unit includes a camera module and obtains the image by direct image capturing using the camera module.

In an aspect, the image obtaining unit includes a communication module and obtains the image by receiving the image from the Internet using the communication module.

In an aspect, the image obtaining unit includes an input/output module and obtains the image by reading a file stored in a local storage using the input/output module.

In an aspect, the location information on the image includes at least one of an azimuth and a GPS coordinate of a place where the image is captured, and the location information on the candidate objects includes at least one a direction and a latitude/longitude coordinate on map according to a location of each object and a center of the image.

In an aspect, the image includes a plurality of objects, and the apparatus further comprises an object of interest selecting unit selecting an object of interest among the plurality of objects.

In an aspect, the candidate object extracting unit extracts a direction of the selected object of interest from a center of the image, searches information on a space, and defines objects in the space as candidate objects.

In an aspect, the space information database includes attribute information including location information on the final candidate object and a name of the final candidate object.

In an aspect, the object information extracting unit extracts a name of the final candidate object based on location information on the final candidate object from the space information database and searches information on the final candidate object using the name of the final candidate object and an Internet search engine.

In an aspect, the space information database includes additional information on the objects, and the object information extracting unit searches the additional information on the objects in the space information database.

According to another aspect of the present invention, there is provided a method of providing augmented reality. The method comprises obtaining an image including objects, extracting unit obtaining location information on the image, extracting a target object by analyzing features of a subject in the image, defining the objects in a space as candidate objects, and extracting information on directions of the candidate objects from a center of the image, determining a final candidate object using the location information on the image, the directions of the candidate objects, and each relationship in phase between the objects, and searching information on the final candidate object based on the location information on the final candidate object in a space information database and displaying the information on the final candidate object on the image.

In an aspect, the image including the objects is obtained by direct image capturing.

In an aspect, the image including the objects is obtained by receiving the image from the Internet.

In an aspect, the image including the objects is obtained by reading a file stored in a local storage.

In an aspect, the location information on the image includes at least one of an azimuth and a GPS coordinate of a place where the image is captured, and the location information on the candidate objects includes at least one a direction and a latitude/longitude coordinate on map according to a location of each object and a center of the image.

In an aspect, the image includes a plurality of objects, and the method further comprises selecting an object of interest among the plurality of objects.

In an aspect, a direction of the selected object of interest from a center of the image is extracted to search information on a space, and objects in the space are defined as candidate objects.

In an aspect, the space information database includes attribute information including location information on the final candidate object and a name of the final candidate object.

In an aspect, a name of the final candidate object is extracted based on location information on the final candidate object from the space information database and information on the final candidate object is searched using the name of the final candidate object and an Internet search engine.

In an aspect, the space information database includes additional information on the objects, and the information on the final candidate object is searched from the space information database.

According to a configuration of the present invention, augmented reality may be implemented in geo-tagged images that may be obtained over the Internet, as well as from a mobile terminal that may be available in real time.

Further, without the need of separately establishing a database for additional information, information on a region may be searched only with the name of the region, and thus, augmented reality may be utilized in a wide-range area but not a limited area.

### BRIEF DESCRIPTION OF DRAWINGS

FIG. 1 is a view illustrating the concept of augmented reality to which the present invention may apply;

FIG. 2 is a block diagram illustrating an apparatus of providing augmented reality according to an embodiment of the present invention;

FIG. 3 is a block diagram illustrating an apparatus of providing augmented reality according to another embodiment of the present invention;

FIG. 4 is a flowchart illustrating a method of providing augmented reality according to an embodiment of the present invention;

FIG. 5 is a flowchart illustrating a method of providing augmented reality according to another embodiment of the present invention; and

FIG. 6 is a view illustrating an example where augmented reality is implemented according to an embodiment of the present invention.

### DETAILED DESCRIPTION OF EMBODIMENTS

Embodiments of the present invention are described with reference to the accompanying drawings in such a detailed manner as they can be easily embodied by one of ordinary skill in the art. However, the present invention may be embodied in other various ways, and is not limited to the embodiments herein. For enforcing clarity, the drawings exclude any part that is not related to the description of the present invention, and throughout the specification, similar reference signs refer to similar elements.

As used herein, when an element “includes” another element, the element may further include other elements without excluding the other element unless stated otherwise. Further, the term “unit” means a basis for processing at least one function or operation and this may be realized in software, hardware, or a combination thereof.

Embodiments of the present invention are described with reference to the accompanying drawings.

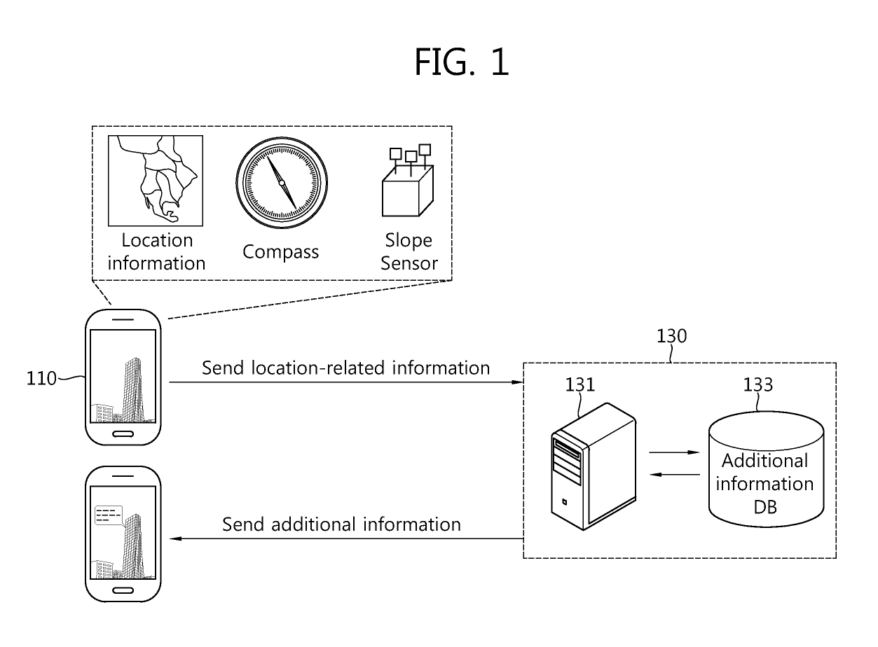

FIG. 1 is a view illustrating the concept of augmented reality to which the present invention may apply. If a user executes an augmented reality application of a terminal 110 and orients the terminal 110 towards an object from which the user intends to obtain information, the terminal 110 sends GPS information such as latitude or longitude, the direction or slope of a compass and sends it to a location information server 131 of a space information system 130. The location information server 131 searches a space information database 133 based on the location information received from the terminal 110 and sends additional information about an object in an image associated with the received location information to the terminal 110. The terminal 110 displays the additional information received from the location information server 131 and the user may obtain the additional information on the object in the image.

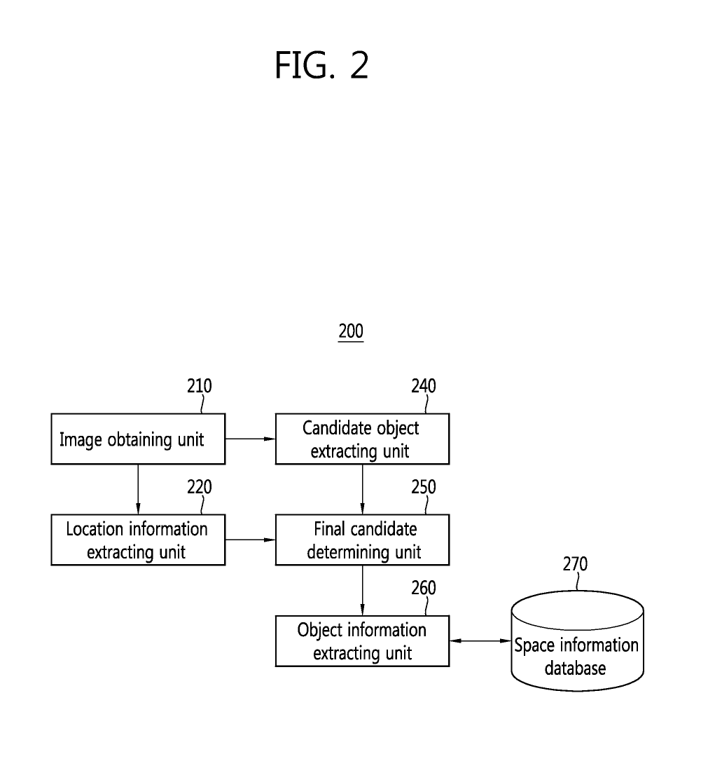

FIG. 2 is a block diagram illustrating an augmented reality providing apparatus 200 according to an embodiment of the present invention.

The augmented reality providing apparatus 200 according to an embodiment of the present invention may be a portable terminal (e.g., a smartphone) that may obtain image information and GPS information, a communication terminal (e.g., a PC) that may obtain from the Internet an image including location information, a terminal embedded in a terminal, a terminal's process and memory. For example, if a portable terminal sends an image including location information over the Internet, a communication terminal may download the image and may extract location information from the header of the image or related meta data. Sensor information including a location may be extracted, in case of a still image, from the header of the still image, and in case of a video, from an image frame and meta data having information on the image frame alongside the header information thereof.

Referring to FIG. 2, the augmented reality providing apparatus 200 according to an embodiment of the present invention may include an image obtaining unit 210, a location information extracting unit 220, a candidate object extracting unit 240, a final candidate determining unit 250, an object information extracting unit 260, and a space information database 270.

The image obtaining unit 210 obtains an image having objects. The objects may include any object that a user is interested in. For example, in case a user photographs a specific region, a specific object or building in the region may be the objects. The image obtaining unit 210 may include a camera module for image capturing and a GPS module for obtaining location information. At the time, the image obtaining unit 210 may obtain a GPS coordinate and an image by direct image capturing using the camera module. The image obtaining unit 210 may include a communication module for receiving an image from the Internet. The image obtaining unit 210 may receive an image including location information from the Internet using the communication module. Further, the image obtaining unit 210 may include an input/output module for reading an image stored in a local storage.

The location information extracting unit 220 extracts location information from an image including the location information about a place where an image has been captured. The location information may include a GPS coordinate or azimuth of an object. According to the present invention, the location where an image has been captured and sensor information associated therewith are defined as an image's location information.

The candidate object extracting unit 240 extracts major objects shown in an image and define the objects as candidate objects, and if the candidate objects are defined, converts the distances between the center of each image and the objects into angles, thereby extracting information regarding the azimuths of the objects with respect to the center of the image.

The final candidate determining unit 250 analyzes the relationship in phase between the objects in the space information database 270 using the object azimuths of the candidate objects, center azimuth, and location information on the image. The phase relationship includes the degree of being close to the capturing location (proximity) and a test of visibility in a horizontal/vertical direction through 3D projection, and the final candidate object of an object of interest is determined including an object that is close to the capturing location or an object that is not hidden by a front object.

The object information extracting unit 260 searches the space information database 270 for information on the final candidate object of the object of interest determined in the final candidate determining unit 250.

The space information database 270 may include only the location information and names of objects and may further include additional information on objects. In case the space information database 270 contains only the location information and names of objects, the object information extracting unit 260 extracts basic attribute information such as the name or address of an object in the space information database 270. For example, if the name of an object is extracted, the object information extracting unit 260 enters the object's name to an Internet search engine and searches for information on the object. The information on the object may be homepage information. Further, the object information extracting unit 260 may access the homepage based on the searched homepage information to extract additional information on the object from the home page.

In case the space information database 270 includes additional information on objects, the object information extracting unit 260 may search additional information on an object in the space information database 270 and may display the searched additional information.

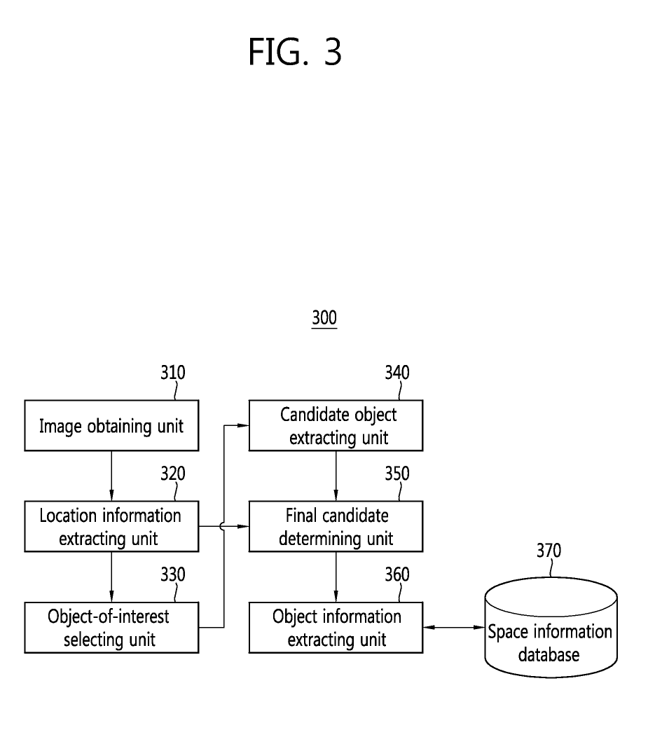

FIG. 3 is a block diagram illustrating an augmented reality providing apparatus 300 according to another embodiment of the present invention.

The augmented reality providing apparatus 300 according to an embodiment of the present invention may be a portable terminal (e.g., a smartphone) that may obtain image information and GPS information, a communication terminal (e.g., a PC) that may obtain from the Internet an image including location information, a terminal embedded in a terminal, a terminal's process and memory. For example, if a portable terminal sends an image including location information over the Internet, a communication terminal may download the image and may extract location information from the header of the image or related meta data. Sensor information including a location may be extracted, in case of a still image, from the header of the still image, and in case of a video, from an image frame and meta data having information on the image frame alongside the header information thereof.

Referring to FIG. 3, the augmented reality providing apparatus 300 may include an image obtaining unit 310, a location information extracting unit 320, an object-of-interest selecting unit 330, a candidate object extracting unit 340, a final candidate determining unit 350, an object information extracting unit 360, and a space information database 370.

The image obtaining unit 310 obtains an image having objects. The objects may include any object that a user is interested in. For example, in case a user photographs a specific region, a specific object or building in the region may be the objects. The image obtaining unit 310 may include a camera module for image capturing and a GPS module for obtaining location information. At the time, the image obtaining unit 310 may obtain a GPS coordinate and an image by direct image capturing using the camera module. The image obtaining unit 310 may include a communication module for receiving an image from the Internet. The image obtaining unit 310 may receive an image including location information from the Internet using the communication module. Further, the image obtaining unit 310 may include an input/output module for reading an image stored in a local storage.

The location information extracting unit 320 extracts location information from an image including the location information about a place where an image has been captured. The location information may include a GPS coordinate or azimuth of an object. According to the present invention, the location where an image has been captured and sensor information associated therewith are defined as an image's location information.

The object-of-interest selecting unit 330 selects an object of interest from an image. In case an image includes a single object, the object is an object of interest. In case an image includes a plurality of objects, the object having the largest area in the image may be an object of interest or an object closest to the center of the image may be an object of interest. Further, a user may be allowed to pick up an object of interest. In case the augmented reality providing apparatus 300 includes a touch display, a user may choose an object of interest by touching the display with his hand. In case the augmented reality providing apparatus 300 includes a mouse, a user may select an object of interest using the mouse. When the augmented reality providing apparatus 300 includes a glasses-type device such as a HMD (Head Mounted Display), an object of interest may be selected by tracking a user's eyes.

The candidate object extracting unit 340 converts the distance between the object of interest selected in the object-of-interest selecting unit 330 and the center of the image into an angle to thereby extract an object azimuth and defines objects having similar azimuths to the object azimuth as candidate objects.

The final candidate determining unit 350 analyzes the relationship in phase between the objects in the space information database 270 using the object azimuths of the candidate objects, center azimuth, and location information on the image. The phase relationship includes the degree of being close to the capturing location (proximity) and a test of visibility in a horizontal/vertical direction through 3D projection, and the final candidate object of an object of interest is determined including an object that is close to the capturing location or an object that is not hidden by a front object.

The object information extracting unit 360 searches the space information database 370 for information on the final candidate object of the object of interest determined in the final candidate determining unit 350.

The space information database 370 may include only the location information and names of objects and may further include additional information on objects. In case the space information database 370 contains only the location information and names of objects, the object information extracting unit 360 extracts basic attribute information such as the name or address of an object in the space information database 370. For example, if the name of an object is extracted, the object information extracting unit 360 enters the object's name to an Internet search engine and searches for information on the object. The information on the object may be homepage information. Further, the object information extracting unit 360 may access the homepage based on the searched homepage information to extract additional information on the object from the home page.

In case the space information database 370 includes additional information on objects, the object information extracting unit 360 may search additional information on an object in the space information database 370 and may display the searched additional information.

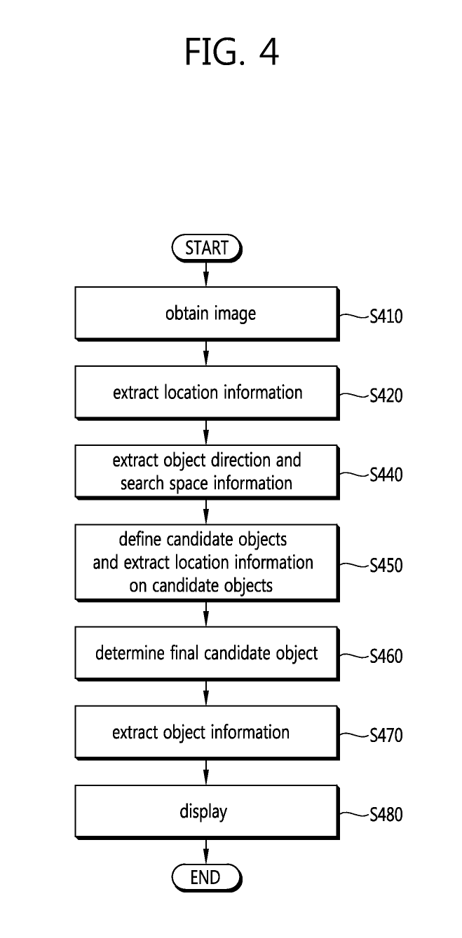

FIG. 4 is a flowchart illustrating a method of providing augmented reality according to an embodiment of the present invention.

The method of providing augmented reality according to FIG. 4 may be performed by the augmented reality providing apparatus 200 shown in FIG. 2.

Referring to FIGS. 2 and 4, the augmented reality providing apparatus 200 obtains an image including an object (S410). The object may be any object that a user is interested in. For example, in case a user photographs a specific region, the object may be a specific object or building in the region. The augmented reality providing apparatus 200 may obtain a GPS coordinate and an image by direct image capturing using a camera module. Further, the augmented reality providing apparatus 200 may receive an image including location information from the Internet. Further, the augmented reality providing apparatus 200 may read an image having location information stored in a local storage and may display the read image.

Next, the augmented reality providing apparatus 200 extracts location information from the image including location information (S420). The location information may include a GPS coordinate and the azimuth of the object.

If the location information on the image is extracted, the augmented reality providing apparatus 200 extracts a featuring object from the center of the image and searches information on the space based on the direction of the extracted object (S440).

If the information on the space is searched, the augmented reality providing apparatus 200 defines objects in the space as candidate objects and extract location information on the candidate objects (S450).

If the location information on the candidate objects is extracted, the augmented reality providing apparatus 200 determines the final candidate object of the object of interest by analyzing the relationship in phase between the candidate objects using the location information on the candidate objects and the location information on the image (S460).

If the final candidate object is determined, the augmented reality providing apparatus 200 extracts information on the determined final candidate object from the space information database 270 (S470).

In case the space information database 270 contains only the location information and names of objects, the augmented reality providing apparatus 200 extracts basic attribute information such as the name or address of an object in the space information database 270. For example, if the name of an object is extracted, the augmented reality providing apparatus 200 enters the object's name to an Internet search engine and searches for information on the object. The information on the object may be homepage information. Further, the augmented reality providing apparatus 200 may access the homepage based on the searched homepage information to extract additional information on the object from the home page.

In case the space information database 270 includes additional information on objects, the augmented reality providing apparatus 200 may extract additional information on an object in the space information database 270.

If the information on the object is extracted, the augmented reality providing apparatus 200 displays the image with the additional information on the extracted object overlapping the image (S480).

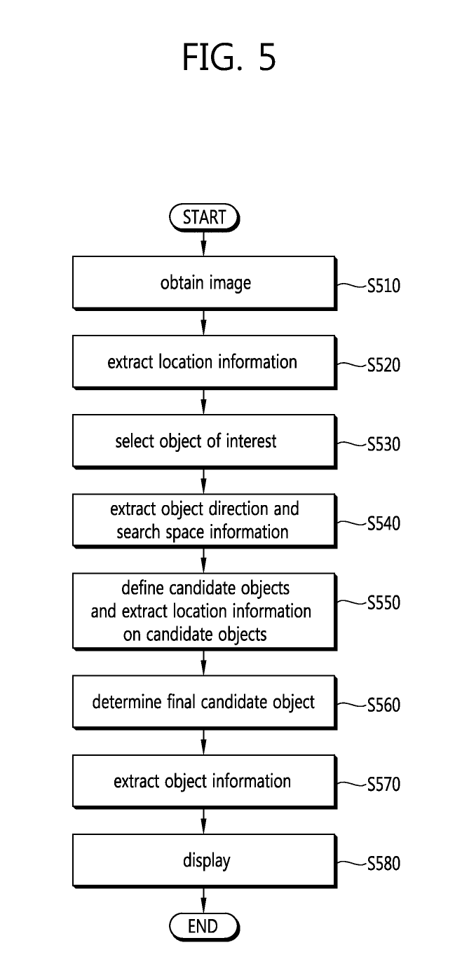

FIG. 5 is a flowchart illustrating a method of providing augmented reality according to another embodiment of the present invention.

The method of providing augmented reality according to FIG. 5 may be performed by the augmented reality providing apparatus 300 shown in FIG. 3.

Referring to FIGS. 3 and 5, the augmented reality providing apparatus 200 obtains an image including an object (S510). The object may be any object that a user is interested in. For example, in case a user photographs a specific region, the object may be a specific object or building in the region. The augmented reality providing apparatus 300 may obtain a GPS coordinate and an image by direct image capturing using a camera module. Further, the augmented reality providing apparatus 300 may receive an image including location information from the Internet. Further, the augmented reality providing apparatus 300 may read an image having location information stored in a local storage and may display the read image.

Next, the augmented reality providing apparatus 300 extracts location information from the image including location information (S520). The location information may include a GPS coordinate and the azimuth of the object.

If the location information on the image is extracted, the augmented reality providing apparatus 300 selects an object of interest from the image (S530). In case an image includes a single object, the object is an object of interest. In case an image includes a plurality of objects, the object having the largest area in the image may be an object of interest or an object closest to the center of the image may be an object of interest. Further, a user may be allowed to pick up an object of interest. In case the augmented reality providing apparatus 300 includes a touch display, a user may choose an object of interest by touching the display with his hand. In case the augmented reality providing apparatus 300 includes a mouse, a user may select an object of interest using the mouse. When the augmented reality providing apparatus 300 includes a glasses-type device such as a HMD (Head Mounted Display), an object of interest may be selected by tracking a user's eyes.

If the object of interest is selected from the image, the augmented reality providing apparatus 300 extracts the direction of the object of interest from the center of the image and searches information on the target space based on the direction (S540).

If the information on the space is searched, the augmented reality providing apparatus 300 defines objects in the space as candidate objects and extracts location information on the candidate objects (S550).

If the location information on the candidate objects is extracted, the augmented reality providing apparatus 300 determines the final candidate object of the object of interest by analyzing the relationship in phase between the candidate objects using the location information on the candidate objects and the location information on the image (S560).

If the final candidate object is determined, the augmented reality providing apparatus 300 extracts information on the determined candidate object from the space information database 370 (S570).

In case the space information database 370 contains only the location information and names of objects, the augmented reality providing apparatus 300 extracts basic attribute information such as the name or address of an object in the space information database 370. For example, if the name of an object is extracted, the augmented reality providing apparatus 300 enters the object's name to an Internet search engine and searches for information on the object. The information on the object may be homepage information. Further, the augmented reality providing apparatus 300 may access the homepage based on the searched homepage information to extract additional information on the object from the home page.

In case the space information database 370 includes additional information on the object, the augmented reality providing apparatus 300 may extract the additional information on the object from the space information database 370.

If the information on the object is extracted, the augmented reality providing apparatus 300 displays the image with the additional information on the extracted object overlapping the image (S580).

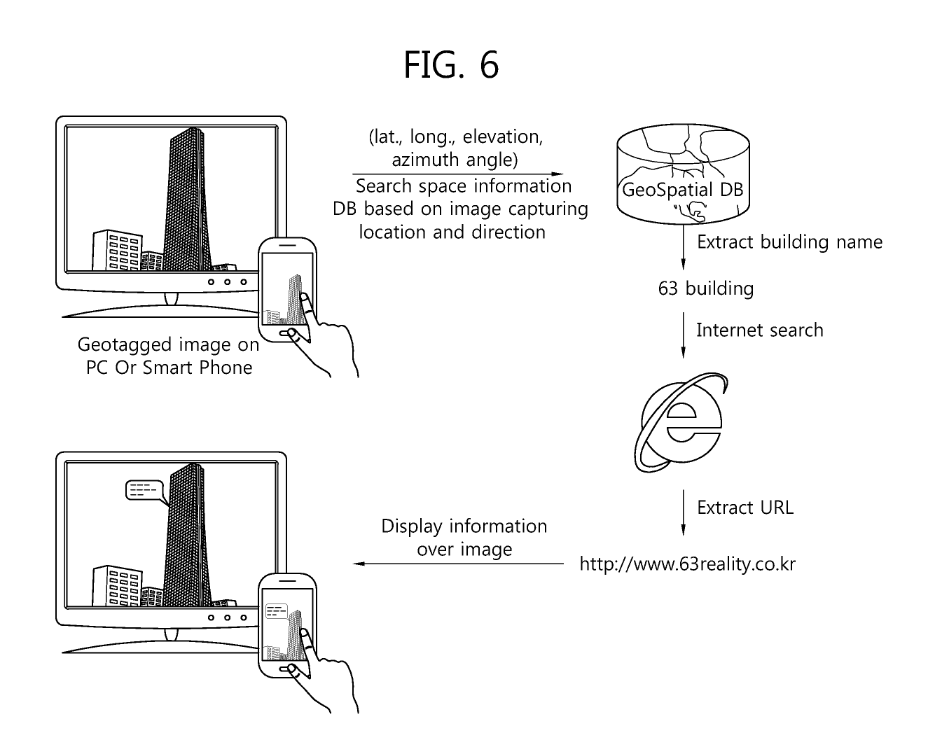

FIG. 6 is a view illustrating an example where augmented reality is implemented according to an embodiment of the present invention.

Referring to FIG. 6, when a user obtains a geo-tagged image using his PC or smartphone, a space information DB is searched based on the image capturing location and direction. For example, if the captured image contains 63 building that is extracted as a candidate object, additional information such as the name of the building, i.e., “63 building,” and address of the building may be extracted from the space information DB based on the location of 63 building. In case the additional information on 63 building is searched from the space information DB, the additional information may be directly displayed on the smartphone, and in case only the name of the building is searched, the name may be entered to a search engine to search additional information that is then displayed on the smartphone.

According to a configuration of the present invention, augmented reality may be implemented on geo-tagged images that are stored in a local storage or geo-tagged images obtainable over the Internet, as well as from a mobile terminal that may be used in real time.

Further, without the need of establishing a separate database, the information on a region can be searched only with the name of the region, so that a broad range of area may be covered for utilization of augmented reality.

Although the present invention has been shown and described with reference to some embodiments thereof, it is apparent to one of ordinary skill in the art that various changes in form and detail may be made thereto without departing from the scope of the present invention defined by the following claims.

What is claimed is:

1. An apparatus of providing augmented reality, comprising:
an image obtaining unit obtaining an image including objects;
a location information extracting unit obtaining location information on the image;
a candidate object extracting unit extracting a target object by analyzing features of a subject in the image, defining the objects in a space as candidate objects, and extracting information on directions of the candidate objects from a center of the image;
a final candidate object determining unit determining a final candidate object using the location information on the image, the directions of the candidate objects, and each relationship in phase between the objects; and
an object information extracting unit searching information on the final candidate object based on the location information on the final candidate object in a space information database and displaying the information on the final candidate object on the image.

2. The apparatus of claim 1, wherein the image obtaining unit includes a camera module and obtains the image by direct image capturing using the camera module.

3. The apparatus of claim 1, wherein the image obtaining unit includes a communication module and obtains the image by receiving the image from the Internet using the communication module.

4. The apparatus of claim 1, wherein the image obtaining unit includes an input/output module and obtains the image by reading a file stored in a local storage using the input/output module.

5. The apparatus of claim 1, wherein the location information on the image includes at least one of an azimuth and a GPS coordinate of a place where the image is captured, and wherein the location information on the candidate objects includes at least one a direction and a latitude/longitude coordinate on map according to a location of each object and a center of the image.

6. The apparatus of claim 1, wherein the image includes a plurality of objects, and wherein the apparatus further comprises an object of interest selecting unit selecting an object of interest among the plurality of objects.

7. The apparatus of claim 6, wherein the candidate object extracting unit extracts a direction of the selected object of interest from a center of the image, searches information on a space, and defines objects in the space as candidate objects.

8. The apparatus of claim 1, wherein the space information database includes attribute information including location information on the final candidate object and a name of the final candidate object.

9. The apparatus of claim 7, wherein the object information extracting unit extracts a name of the final candidate object based on location information on the final candidate object from the space information database and searches information on the final candidate object using the name of the final candidate object and an Internet search engine.

10. The apparatus of claim 1, wherein the space information database includes additional information on the objects, and wherein the object information extracting unit searches the additional information on the objects in the space information database.

11. A method of providing augmented reality, comprising:
obtaining an image including objects;
extracting unit obtaining location information on the image;
extracting a target object by analyzing features of a subject in the image, defining the objects in a space as candidate objects, and extracting information on directions of the candidate objects from a center of the image;
determining a final candidate object using the location information on the image, the directions of the candidate objects, and each relationship in phase between the objects; and
searching information on the final candidate object based on the location information on the final candidate object in a space information database and displaying the information on the final candidate object on the image.

12. The method of claim 11, wherein the image including the objects is obtained by direct image capturing.

13. The method of claim 11, wherein the image including the objects is obtained by receiving the image from the Internet.

14. The method of claim 11, wherein the image including the objects is obtained by reading a file stored in a local storage.

15. The method of claim 11, wherein the location information on the image includes at least one of an azimuth and a GPS coordinate of a place where the image is captured, and wherein the location information on the candidate objects includes at least one a direction and a latitude/longitude coordinate on map according to a location of each object and a center of the image.

16. The method of claim 11, wherein the image includes a plurality of objects, and wherein the method further comprises selecting an object of interest among the plurality of objects.

17. The method of claim 15, wherein a direction of the selected object of interest from a center of the image is extracted to search information on a space, and objects in the space are defined as candidate objects.

18. The method of claim 11, wherein the space information database includes attribute information including location information on the final candidate object and a name of the final candidate object.

19. The method of claim 17, wherein a name of the final candidate object is extracted based on location information on the final candidate object from the space information database and information on the final candidate object is searched using the name of the final candidate object and an Internet search engine.

20. The method of claim 11, wherein the space information database includes additional information on the objects, and the information on the final candidate object is searched from the space information database.
